(19) United States
(12) Patent Application Publication
(10) Pub. No.: US 2010/0199306 A1
(43) Pub. Date: Aug. 5, 2010

(54) Method and Apparatus for User Interface Movement Scheme

(76) Inventors: David Colter, Sammamish, WA (US); Alex Chung, New York, NY (US); Marc McConnaughey, Chino, CA (US); Stephanie Otto, Lake Oswego, OR (US); Michael Onaitis, Lake Oswego, OR (US)

Correspondence Address: DLA PIPER US LLP, 1999 AVENUE OF THE STARS, SUITE 400, LOS ANGELES, CA, 90067-6023, US

(21) Appl. No.: 12/684,088

(22) Filed: Jan. 7, 2010

Related U.S. Application Data
(60) Provisional application No. 61/143,118, filed on Jan. 7, 2009.

(51) Int. Cl. H04N 5/445

(52) U.S. Cl. 725/38

(57) ABSTRACT

The system provides a method and apparatus for implementing an electronic menu navigation system to present a range of categories and content items within each category to the user, and to allow the user to browse the categories with a cascading movement. Within each category the user can navigate left and right to view the items contained in that category. The new navigation is implemented as a cascading browser or cascading menu. The menu is presented as a plurality of tiers with each tier having a plurality of seats. The effect is three dimensional and similar to viewing audience seating from a stage.

This invention claims priority to U.S. Provisional Patent Application No. 61/143,118 filed Jan. 7, 2009, which is incorporated by reference herein in its entirety.

### BACKGROUND

1. Field of the System

This system relates to the field of menu driven presentation of user choices.

2. Background

Electronics users are comfortable using menu driven systems such as those found on personal computers, game systems, PDA's, MP3 players, DVR's, televisions, and nearly any device that has some sort of display screen. However, some menu driven systems are easier to user than others. For example, a menu driven PC is easy to use due to the ability to combine a free flowing pointing device, such as a mouse, with a full keyboard for those times when data entry might be required. Devices that lack either a mouse or a keyboard can be more awkward to use.

One device that has become more menu driven over time is the home television. The use of VCR's, DVR's, On-Demand, initial parameter set-up, and other functionality has created the need for some menu driven feature selection on a television. However, most televisions lack a full keyboard and/or a free flowing pointing device. Often the user is limited to using up-down and left-right keys to initiate cursor movement on the television screen. This same device may also be the path for entering alpha-numeric information such as names of movies, programming times, channels, etc.

One type of prior art television menu is the so called “channel guide”. Often this consists of a grid of channel and time where the user can navigate up and down to move from channel to channel, and left and right to move from one time of day to another. (In some embodiments the channel/time axes are reversed). Some systems allow a form of filtering where a category can be selected and only those shows that match that category (e.g. sports, movies, etc.) are shown.

In one embodiment, the user may use the numeric keypad of a remote control to enter a specific channel. The guide then displays the information associated with that channel, and perhaps consecutive available channels in the same channel range as the selected channel.

One problem with implementing television menus in the prior art is the limited navigability of the system and the limited amount of information that can be displayed in a grid pattern. The size of the grids is limited by the ability of the viewer to easily read the information contained therein. This limits the number of rows and columns that can be viewed at any one time by the viewer. If a viewer desires to scroll through the menu to see what might be of interest, the limited number of items in the grid requires a large number of clicks or movements to get through the entire menu. With hundreds of channels available, this can be a limiting factor in the enjoyment of the system.

### BRIEF SUMMARY OF THE SYSTEM

The system provides a method and apparatus for implementing an electronic menu navigation system to present a range of categories and content items within each category to the user, and to allow the user to browse the categories with a cascading movement. Within each category the user can navigate left and right to view the items contained in that category. The new navigation is implemented as a cascading browser or cascading menu. The menu is presented as a plurality of tiers with each tier having a plurality of seats. The effect is three dimensional and similar to viewing audience seating from a stage.

The categories can describe a content genre, content type, channel, top ten (or “top n” list where n is a number) list, or content grouped using a number of different user related filters. The items can be specific content titles, possible actions, time sequences, etc.

The system provides a plurality of menu views including a full screen version as well as a “dock” version where the menu is combined with a display image such as a video image from a selected content source.

### BRIEF DESCRIPTION OF THE DRAWINGS

FIG. 1 illustrates an example embodiment of a user interface of the system.

FIG. 2 illustrates movement in the user interface of FIG. 1.

FIG. 3 illustrates the completion of the movement action of FIG. 2.

FIG. 4 is an example of a remote control that can be used with the system.

FIG. 5 is a block diagram of an example embodiment of the system.

FIG. 6 is a flow diagram of an embodiment of the system.

FIG. 7 is a flow diagram of menu assembly in an embodiment of the system.

FIG. 8 is a flow diagram of xxx

### DETAILED DESCRIPTION OF THE SYSTEM

The system provides an improved movement, navigation, and user interface that can be used with any screen display, including televisions, monitors, computers, PDAs, MP3 players, DVRs, etc. The system provides a richer on-screen menu environment while still allowing a viewer to use traditional remote control functions. The system allows more information to be viewed at one time by presenting slightly overlapping tiers of graphically presented content.

The system presents a series of tiers of seats on the display. Each seat in the front tier of seats is large enough to be easily read and provides information pictorially as well as graphically. Selecting an item can bring up more textual information as desired. The seats of each receding tier are slightly smaller and overlapping. Even so, the user is presented with enough graphical information to allow the user to understand what is available in the seats of those tiers with just a glance. If something appears of interest, the tier can be cascaded forward to allow easier viewing.

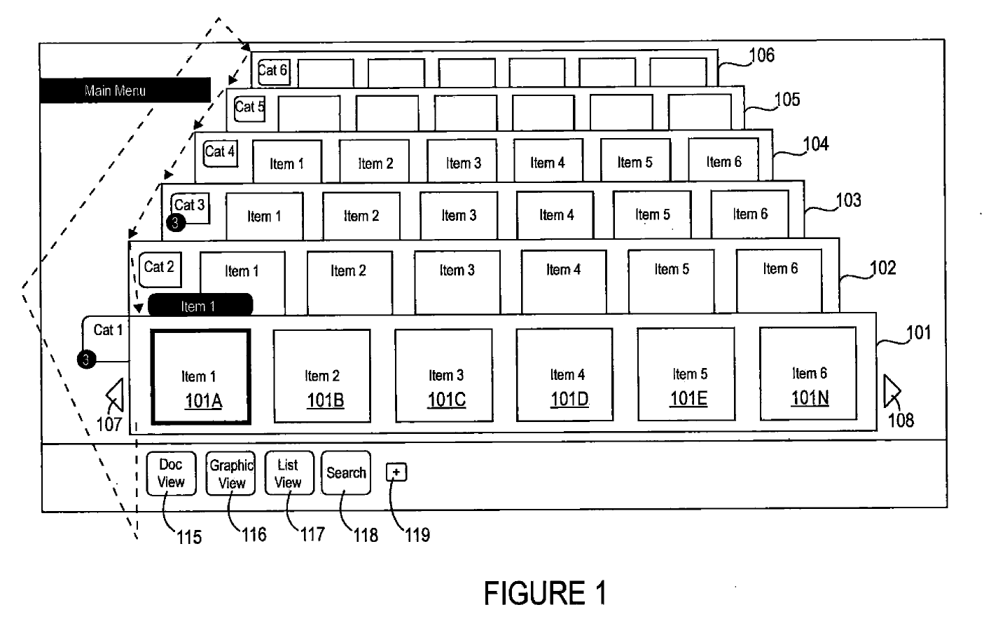

FIG. 1 illustrates an embodiment of the user interface of the system. In FIG. 1 we a plurality of tiers 101-106. Each tier has a plurality of seats such as seats 101A-101N. In one embodiment, categories are represented by horizontal tiers 101-106. However, this is for purposes of example only. In another embodiment, one, some, or all tiers could be from a single category. In one embodiment, each seat can represent a category. When a category is selected, the display changes and all of the seats are now options in the selected category.

Each tier has a plurality of seats 101A-101N that each represent an item in that category. For example, category 101 includes entries 101A-101N each representing an item in that category. Left and right artier buttons 107 and 108 indicate that left and right movement is possible in that tier so that more seats may be made visible in the tier by using the left and right directional artiers on a remote control. The directional controls also can be used to move from one entry to another in a selected tier/category.

As can be seen in FIG. 1, the configuration of the system allows more options to be viewed than in prior art grid based systems. A typical prior art grid system has five tiers and shows a span of 1-2 hours of programming time, usually in half hour to one hour blocks. This results in ten to twenty programs to be visible on the screen. By contrast, the present system illustrates an embodiment with six seats in each of six tiers, a total of 36 options available. Because the seats in one embodiment are graphical instead of textual, information is more easily gained at a glance.

The system uses a cascade system of movement for navigation. As the user enters the cascade menu one tier (e.g. tier 101) is in primary focus at the front of the cascade. As the user selects an up artier with the remote or navigation device the entire tier in primary focus slides below the field of view and moves to the back of the tier list/cascade, and the tiers formerly behind each move forward in a cascading motion. The tier directly behind the original tier in primary focus moves into the primary focus position. For example, category/tier 102 would move to the front position, while tier 101 would move to the rear position. (Note that this could be reversed depending on the selection of the up/down directional command on the remote).

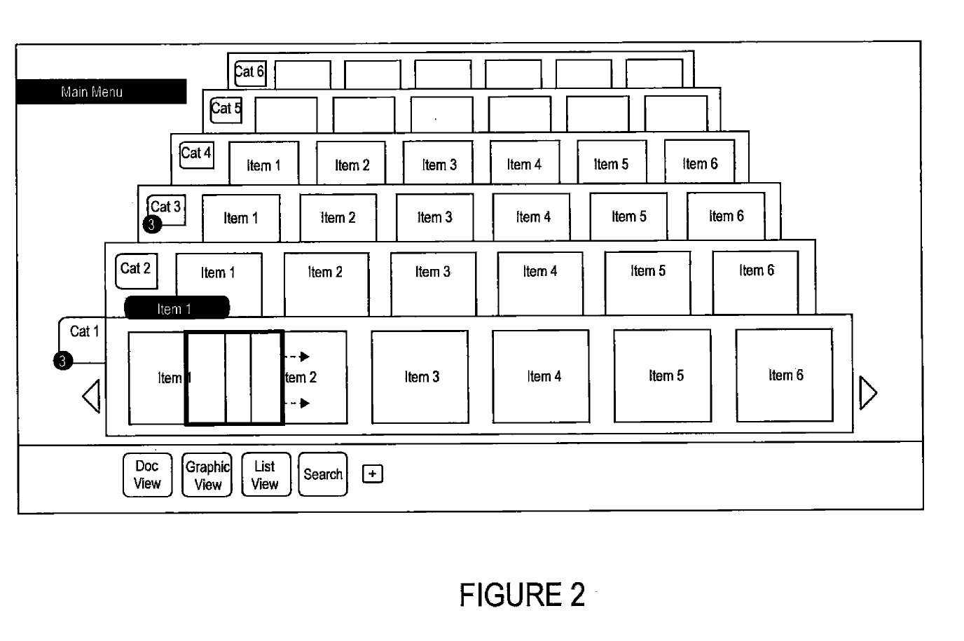

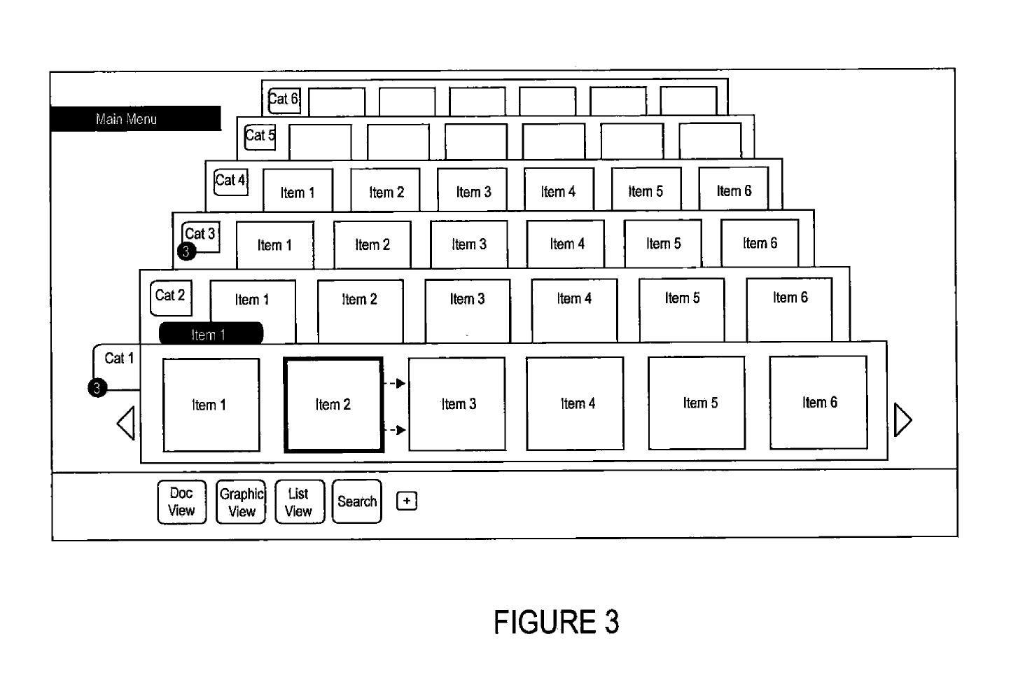

For the tier in the primary focus position the user can move the highlighting frame across the category from item to item (left or right) and take further action on the highlighted seat. FIGS. 2 and 3 show the movement of the highlight frame moving from Item 101A to Item 101B within the primary focus category 101. FIG. 2 shows the highlight frame 110 in mid-position between entries 101A and 101B. FIG. 3 shows the highlight frame 110 after it has reached entry 101B.

The system includes a number of buttons 115-119 on the bottom tier that can be used to assist navigation. Button 115 is a Doc View button and is the currently selected view in FIGS. 1-3. Button 116 is a Graphic View button and provides a different presentation of the choices. Button 117 is a List View button that provides a sorted list of choices and button 118 is a Search button that can be used to find an entry, category, or item. FIG. 119 is a button to enlarge the image as desired.

The system contemplates a corresponding remote control or navigation device that is used to move an on-screen indicator. Once an item is highlighted the user can select that item with a remote or navigation device and then the entire cascade can change to represent a new set of categories and items that the user can then navigate using the same movement within the cascade. In some cases, selecting the seat initiates playback.

The menu is provided for all sources of content on the television. This includes DVD players, gaming devices, movie services, internet services, broadcast channels, DVR sources, television settings, television applications, photos, music, and the like. The number of categories presented in the cascade can vary depending on the type of source or content being considered.

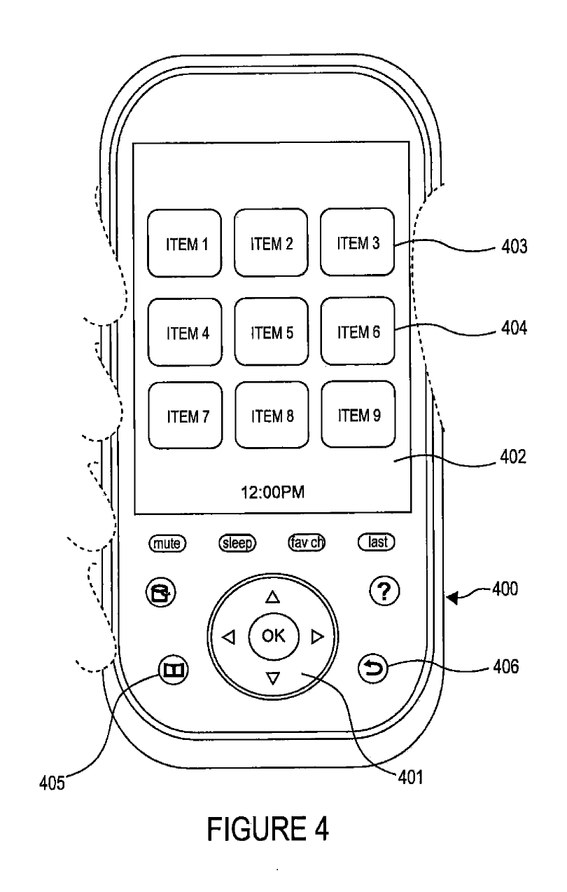

FIG. 4 is an example of a remote control that could be used with the system. This remote control is shown by way of example only and other remote controls may be used without departing from the spirit and scope of the system. Remote control 400 includes a navigation wheel 401 that has up, down, left, right, and OK controls. The navigation wheel is used to control position and movement of an onscreen curser or highlight indicator. The OK button is used to activate a selected item on the screen. The remote 400 can include a number of function buttons such as buttons 405 and 406, or the buttons in tier 407. In the embodiment of FIG. 4, the remote includes a touch-screen 402 that can display any number of functions and options that can be used in association with the television. Functions can appear that are dependent on the device being used (TV, DVD, DVR, etc.). In the example, shown, channel logos such as ABC 403 and CNN 404 are displayed in the touch-screen area 402. In one embodiment the remote 400 is an infrared remote and includes an infrared emitter to transmit commands to an infrared receiver on the TV or other connected devices. The remote can be a learning remote, universal remote, or dedicated remote as desired. Typically, the remote will include a battery power supply, a processor, memory, and code translation for translating commands to infrared codes to be transmitted to, and to control, various devices.

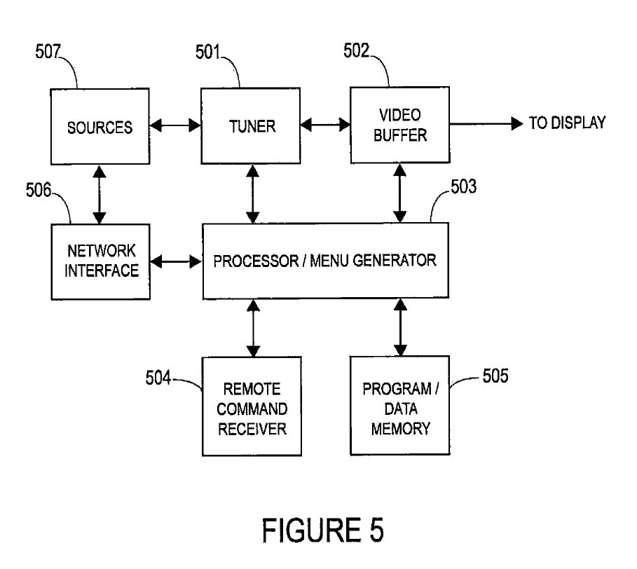

FIG. 5 is a block diagram of an embodiment of the system. A processor/menu generator 503 executes code stored in program data memory 505 and controls the function of the television. For example, the CPU processes certain data to control the generation of the menu as shown in FIGS. 1-3. The processor/menu generator receives and processes the user input, received from the remote/command receiver 504 to provide the user functionality and access to system settings and parameters. In addition, the processor accesses user settings/preferences stored in memory 505 for processing of information and configuration of the system. When a menu is to be displayed, the processor 505, controlled by programs stored in memory 505, generates the menu and provides it to video output 502 where it may be overlaid onto, replace, or combined with other video data for display.

The system includes a plurality of content sources 507 which may include DVD, DVR, VCR, game system, camera, home video, streaming video, video-on-demand, pay-per-view, and the like, as well as a tuner 501 to receive broadcast video content such as over the air (OTR), cable, satellite, and the like. In one embodiment, the system includes internet access via network interface 506, which may be hard wired or wireless as desired.

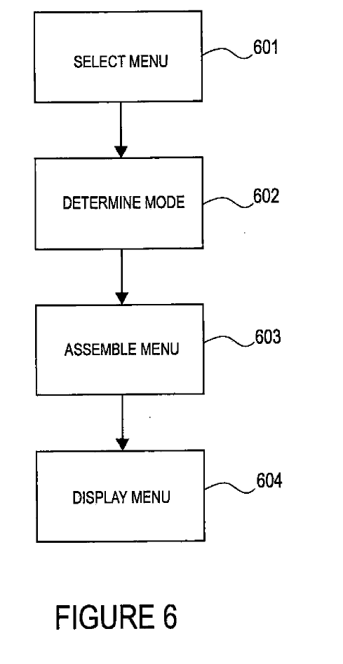

FIG. 6 is a flow diagram illustrating the operation of an embodiment of the system to generate a menu. At step 601 the user activates the menu process by selecting menu on the remote control or by pressing a button on the television itself, or by otherwise issuing a command to the system to display a menu. At step 602 the system determines which mode it is in so that the proper menu can be displayed. For example, if the user is watching television, the default mode might be a program guide of currently and subsequently available programs on the current and nearby channels. In other instances it could be a guide of available movies from a service such as on-demand, Netflix, premium channels, or the like. The mode could be specific to a DVR, DVD player, game system, etc.

At step 603 the appropriate menu for the mode is assembled. At step 604 the menu is displayed for the user.

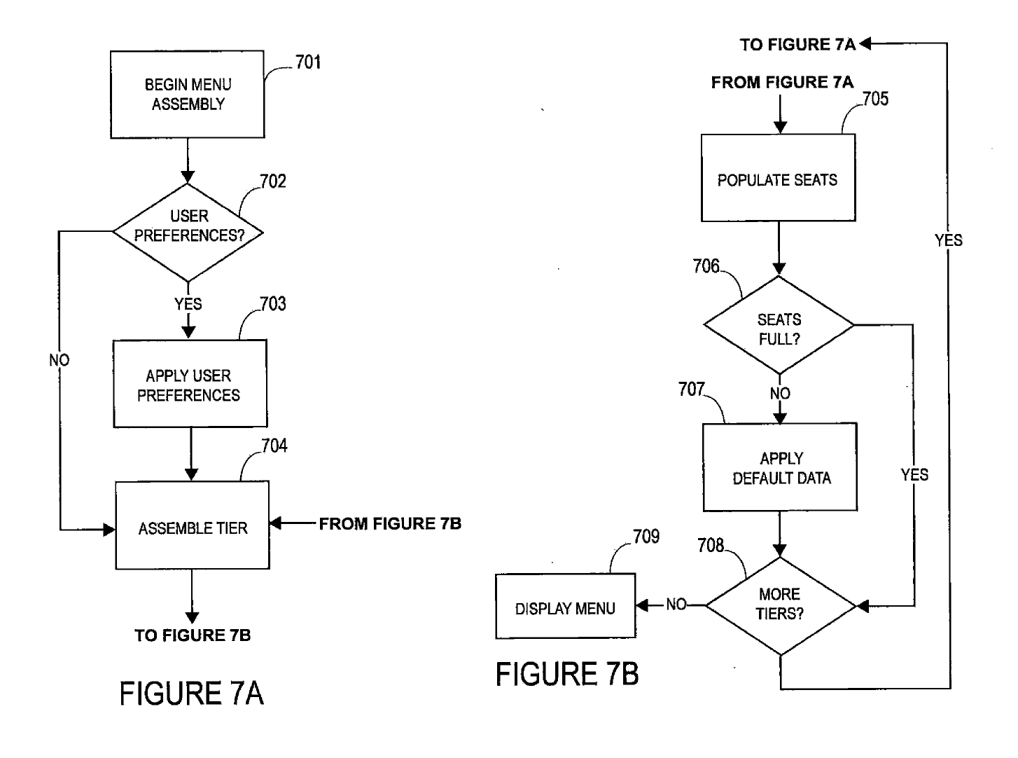

FIG. 7 is a flow diagram illustrating some of the steps in assembling and displaying a menu. At step 701 the system begins menu assembly. At this point the system has already determined the mode it is in and which type of menu is appropriate. At step 702 the system determines if there are user preferences that could affect the look and/or contents of the menu to be displayed. If so, the system applies the user preferences at step 703. If not, or after step 703, the system assembles a tier of the menu. At step 705 the system populates the seats of the tier.

At step 706 it is determined if the seats of the tier are full. That means was there specific content relevant to the mode that is to be inserted into each seat of the tier. If not, then the system applies default data to the empty seats at step 707. This default data could be suggestions, promotions, branded logos, other category selections, and the like. After step 707, or if the seats are full at step 706, the system checks to see if more tiers need to be assembled at step 708. If so, the system returns to step 704. If not, the system displays the menu at step 709.

An example of such an assembled menu is illustrated in FIGS. 1-3. Referring again to FIG. 1, each seat of the front row will be populated with a combination of graphics and text that is appropriate for the mode of the television. The system could display TV shows, TV Apps, Disc (for a Blu Ray/DVD player), Movies, Photos, Music, Settings, and others. When the menu is displayed, the Remote Control 400 has the following commands and functions.
Up Arrow—will cascade the menu up to the next row
Down Arrow—will cascade the menu up to the next row
Left Arrow—will move the highlight to the next position on the left
Right Arrow—will move the highlight to the next position on the right
Select—it will take the user to the designated screen, such as the next level or the detail screen
Play—will play the asset, if appropriate
Menu—if the user is in ¾ video view+Dock, it will automatically place the highlight on the first item in the Dock, which is Full Screen Menu Icon. If in Full

Screen Menu, it will place the highlight on the first item in the Dock, which is the Dock icon.

In one embodiment of the system, the mode of the system determines the contents of the first tier. For example, in Movie mode, the visible seats of the front tier are filled with movie sources that are available to the system, such as Netflix, HBO, ShowTime, YouTube, Cinemax, etc. If there are more movie sources than visible seats in the front tier, then the right and left indicators 107 and 108 become active and the user can use the left and right arrow keys to display additional seats in a scrolling fashion.

In such an embodiment, each tier behind the front tier represents another mode of the system, such as TV, Photos, Music, Applications, Podcasts, etc. which are placed in the three dimensional perspective to create depth and further showcase the spatial navigation of the interface. Each of the seats in the rear tiers is populated by a graphical representation of what is available. For example, for Music, the seats may each represent a music source. For photos, each seat may represent a photo album created by the user, and so on.

In an alternate embodiment, each seat of each tier may display content appropriate only to the current mode (i.e. Movies).

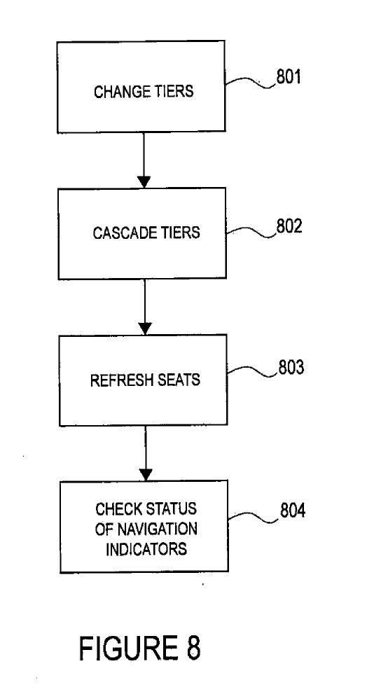

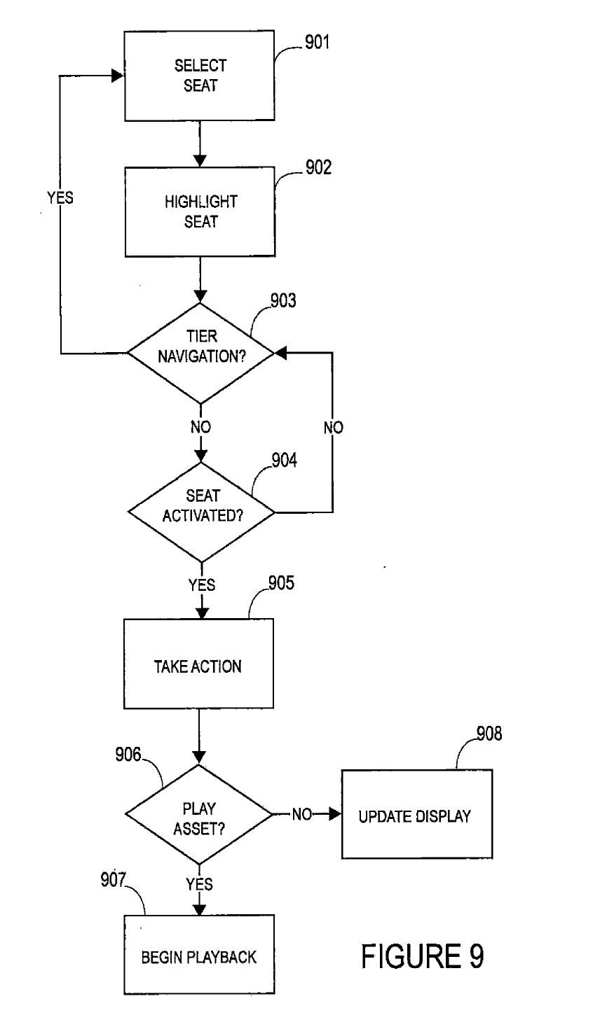

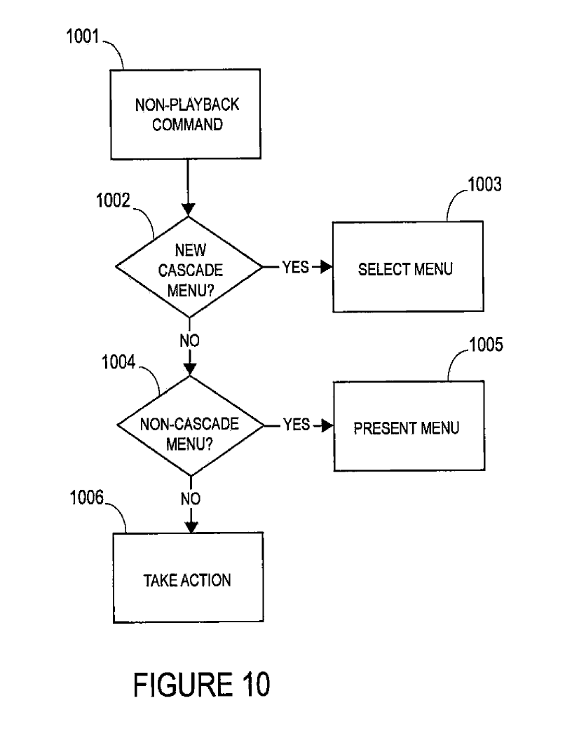

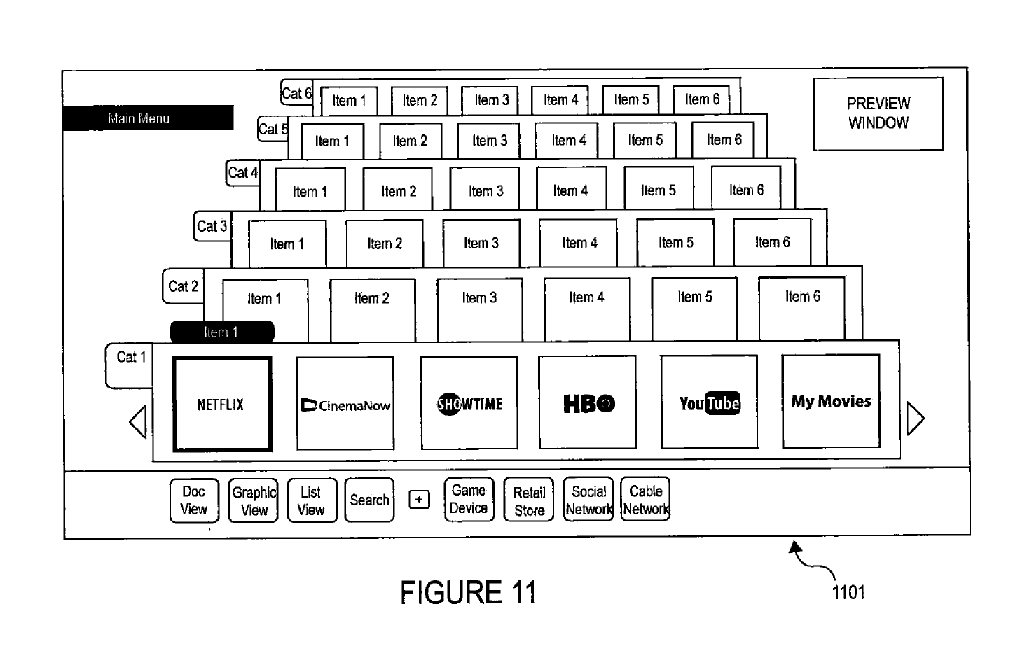

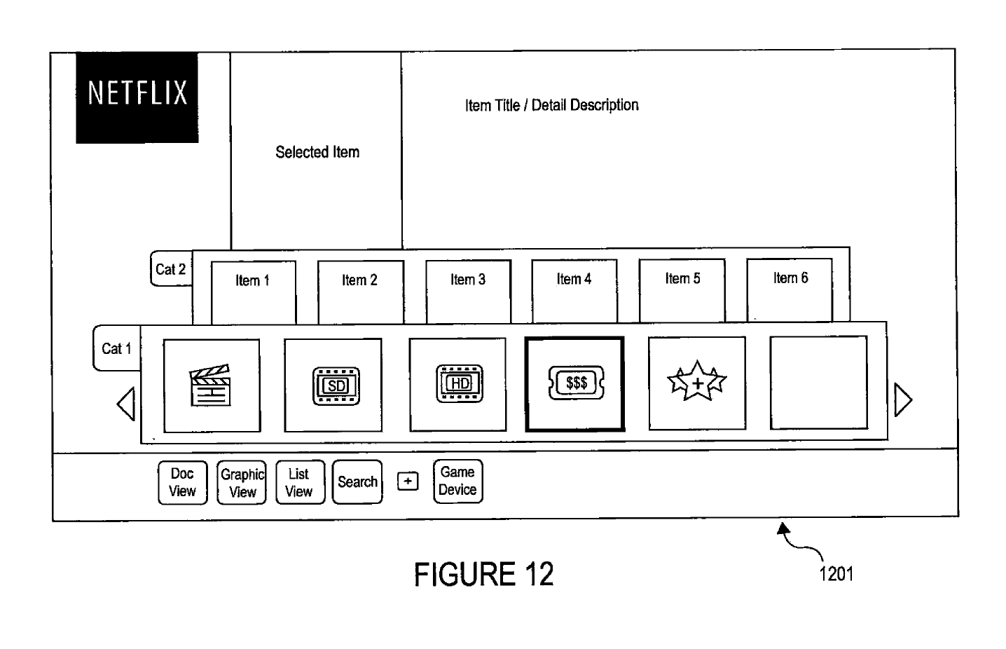

FIG. 8 illustrates the operation of the system when cascading the tiers in response to a navigational command. At step 801 the system receives a command to select another tier. In one embodiment of the system, the cascading of the tiers is always rear toward front whether the up or down navigational arrow of the remote control is activated. In an alternate embodiment, the up arrow moves tiers front to back and the down arrow moves tiers back to front.

At step 802 the front tier is rotated from the front tier to the back tier and each tier moves forward one position. The tier that was previously the second tier now becomes the first tier, and so on. At step 803 the contents of each seat are refreshed so that the appropriate image is displayed. (The seats of the second tier had been partially blocked, now those seats are in full view and are refreshed accordingly. At step 804 it is determined if the left and right indicators 107 and 108 should be shown as active or not and are updated accordingly. In the situation where there are more categories or modes than the number of displayed tiers, the previously first tier disappears during such cascading, and a previously hidden category becomes visible in the back tier.

FIG. 9 illustrates the operation of the system when the user moves within a tier and selects a seat. At step 901 a seat in a tier is selected. At step 902 that seat is surrounded with a frame to indicate that it has been selected. This is by way of example only as other indicators may be used to indicate a seat has been selected, such as brightening, color change, flashing, and the like.

At decision block 903 it is determined if the user has navigated horizontally within the tier. If so, the system returns to step 901 to the next selected seat. If not, the system proceeds to decision block 904. (Note, if the user navigates vertically, the system proceeds to the process of FIG. 8 for tier navigation).

If the user is not navigating from the seat at step 903, the system proceeds to decision block 904 to determine if the seat has been activated, that is if the user has selected the OK button for example, to initiate a procedure associated with the seat. If not, the system returns to step 903. If so, the system proceeds to step 905 and initiates an action associated with the seat.

At decision block 906 it is determined if the command to the seat is to play the asset represented by the seat. For example, if the seat represented a movie or a channel selection, then the system would proceed to play the movie or begin playback of the channel at step 907. If not, the system proceeds to step 908 and updates the display.

The update at step 908 is illustrated in the flow diagram of FIG. 10. At step 1001 the non-playback command is selected. At decision block 1002 it is determined if the result of the command is to proceed to a new cascade menu. This may occur when the user selects, for example, a movie provider that is identified on the seat of a tier of movie providers. One embodiment is such that a new set of tiers is provided with each seat of each tier being an available movie for viewing. Each tier could be a genre or the configuration could be based on user preferences. If a new cascade menu is required, the system proceeds to step 1003 and selects a menu based on the steps of FIG. 6.

If the answer is no at decision block 1002, the system checks at step 1004 to see if a non-cascade menu is called for. This may occur when the action take results in additional information being presented to the user. For example, the action may be to present scheduling, title, cast, and plot information for a program (movie or TV show) that has been selected but is not available for immediate feedback. The user may be given the chance to purchase the program, schedule a recording of the program using a DVR or other recording device, or other options. If so, the system presents the non-cascade menu at step 1005.

If the system is not presenting more menus, then the appropriate action for the selection is taken at step 1006.

### Display Embodiments

The system contemplates a number of embodiments of the cascading menu. In one embodiment, illustrated in FIG. 11, a miniature version 1101 of a program being presented is shown in the upper right hand of the display. This allows the user to continue monitoring the program while still browsing menus.

FIG. 12 illustrates a variation where there is a region 1201 that provides more information about a selected seat by obscuring the back tiers of seats and replacing them with the informational region 1201. In other embodiments, the menus are reduced to a “dock” type of position, typically along the bottom of the screen, so that the video being presented is slightly smaller. When the menu is deselected, the entire screen is available for playback.

The system contemplates implementation as software or firmware in conjunction with a processing system. Typical computer system components including permanent and temporary storage, operating system, input/output, processor, etc. may be used to implement an embodiment of the system.

What is claimed is:

1. A method of presenting a television menu comprising:
displaying a first tier comprising a plurality of first tier seats;
displaying a second tier comprising a plurality of second tear seats wherein each of the second tier seats is partially obscured by a corresponding one of the first tier seats;
providing a moveable indicator to identify one of the first tier seats as an active seat;
taking an action when the active seat is activated.

2. The method of claim 1 further including:
rotating the first tier into the second tier location and the second tier into the first tier location in response to a vertical movement command.

3. The method of claim 2 wherein the first tier represents a category of options for the television.

4. The method of claim 3 wherein each first tier seat represents a source of programming for the category.
